(19) United States
(12) Patent Application Publication
(10) Pub. No.: US 2025/0199505 A1
(43) Pub. Date: Jun. 19, 2025

(54) MACHINING ASSISTANCE APPARATUS

(71) Applicant: FANUC CORPORATION, Yamanashi (JP)

(72) Inventor: Takashi MIYOSHI, Yamanashi (JP)

(21) Appl. No.: 18/292,341

(22) PCT Filed: Aug. 25, 2021
(86) PCT No.: PCT/JP2021/031135

§ 371 Date: Dec. 12, 2024

(51) Int. Cl. G05B 19/4093

(52) U.S. Cl. CPC G05B 19/40932; G05B 2219/37346; G05B 2219/45236

(57) ABSTRACT

This machining assistance apparatus, which calculates various types of data relating to the machining by a machine tool that cuts a workpiece into a polygon shape by rotating the workpiece and the tool at a constant rate, receives input of information relating to the machining, including information relating to the number of polygon surfaces of the workpiece formed by cutting and the number of blades attached to the tool, sets in advance the axial rotation speed of the tool and the workpiece, calculates the rotation speed ratio of the tool with respect to the number of polygon surfaces on the basis of the number of polygon surfaces and the number of blades, calculates an axial rotation speed, or a candidate thereof, of the tool and the workpiece on the basis of the rotation speed ratio within the set range of the axial rotation speed of the tool and workpiece, and outputs and displays the calculation result on a display unit that is connected to the machining assistance apparatus.

### TECHNICAL FIELD

The present invention relates to a machining assistance apparatus, and more specifically to a machining assistance apparatus for assisting polygon machining on a workpiece.

### BACKGROUND ART

Conventionally, there is polygon machining, in which a workpiece is cut into a polygon shape by rotating a tool and the workpiece at a constant ratio. In polygon machining, a cutting edge of the tool draws an elliptical trajectory with respect to the workpiece. When an operator of a machine tool changes a rotation ratio of the workpiece and the tool or the number of tools, a phase and the number of elliptical trajectories change, and the workpiece can be machined into a polygonal shape such as a square or a hexagon.

Polygon machining is achieved by causing a controller of the machine tool to read a machining program and executing the read machining program by the controller.

### CITATION LIST

### Patent Document

Patent Document 1: JP 2015-43126 A

### SUMMARY OF THE INVENTION

### Problem to be Solved by the Invention

However, the machining program for obtaining a desired polygonal shape requires the operator himself to set respective conditions through trial and error. The conditions to be set include a wide variety of conditions, such as a reference position of a workpiece, a diameter of an inscribed circle of a polygon, a rotation ratio of the workpiece and the tool, a phase angle of the workpiece, and so on. A burden of program creation is heavy for the operator.

Furthermore, when a dimensional error with a target dimension occurs during polygon machining, the operator needs to separately perform calculation to adjust the error. Furthermore, it is not known in advance whether or not the desired polygon shape can be machined using a tool or machine tool that is owned, and the operator is required to verify whether or not the machining is possible. In addition, when the operator has a plurality of models of polygon machining tools (hereinafter referred to as rotary tools) attachable to machine equipment, it is difficult for the operator to select a tool preferably used to obtain an optimal polygon machining condition.

Therefore, there is a need for a machining assistance apparatus that has a function of assisting the operator of the machine tool in creating a machining program for polygon machining.

### Means for Solving Problem

An aspect of the invention is a machining assistance apparatus for calculating various data related to machining processing of a machine tool for cutting a workpiece into a polygon shape by rotating the workpiece and a tool at a certain ratio, and the machining assistance apparatus includes an input receiver including a number-of-polygon-faces input receiver configured to receive information related to the number of polygon faces of the workpiece formed by the cutting and a number-of-blades input receiver configured to receive input of information related to the number of blades attached to the tool, the input receiver being configured to receive input of information related to the machining processing, a speed range setter configured to set axis rotation speeds of the tool and the workpiece in advance, a calculator including a rotation speed ratio calculator configured to calculate a rotation speed ratio of the tool to the number of polygon faces based on the number of polygon faces and the number of blades, and a rotation speed calculator configured to calculate axis rotation speeds of the tool and the workpiece or candidates thereof based on the rotation speed ratio within a range of the set axis rotation speeds of the tool and the workpiece, and a display output unit configured to output a calculation result by the calculator to a display unit connected to the machining assistance apparatus, and to cause the display unit to display the calculation result.

### Advantageous Effect of the Invention

According to an aspect of the invention, there are characteristic effects in that it is possible to reduce a burden on an operator in creating a polygon machining program, and the operator can verify in advance whether or not machining into a desired polygonal shape is possible using a tool or machine that is owned.

### BRIEF DESCRIPTION OF DRAWINGS

FIG. 1 is a hardware configuration diagram of a machining assistance apparatus in the present disclosure;

FIG. 2 is a block diagram illustrating an example of the machining assistance apparatus in the present disclosure;

FIG. 3 is a block diagram illustrating an example of a numerical controller equipped with the machining assistance apparatus in the present disclosure;

FIG. 4A is a diagram illustrating a difference in shape of a workpiece surface occurring in response to a difference in polygon machining conditions;

FIG. 4B is a diagram illustrating a difference in shape of a workpiece surface occurring in response to a difference in polygon machining conditions;

FIG. 5 is a block diagram illustrating another embodiment of the machining assistance apparatus in the present disclosure;

FIG. 6 is a diagram illustrating an example of a method of calculating a dimensional error;

FIG. 7A is a diagram illustrating workpiece machining states before and after adjustment of a dimensional error;

FIG. 7B is a diagram illustrating workpiece machining states before and after adjustment of a dimensional error;

FIG. 8 is a block diagram illustrating an alternative of a calculator included in the machining assistance apparatus in the present disclosure;

FIG. 9A is a diagram illustrating an example when replacement of a tool for cutting a certain face of a workpiece is performed during polygon machining;

FIG. 9B is a diagram illustrating an example when replacement of a tool for cutting a certain face of a workpiece is performed during polygon machining;

FIG. 10 is a block diagram illustrating a main part of still another example of the machining assistance apparatus in the present disclosure;

FIG. 11A is a diagram illustrating a relationship among the number of blades of a rotary tool, a rotation speed ratio, and a phase of the rotary tool;

FIG. 11B is a diagram illustrating a relationship among the number of blades of a rotary tool, a rotation speed ratio, and a phase of the rotary tool;

FIG. 11C is a diagram illustrating a relationship among the number of blades of a rotary tool, a rotation speed ratio, and a phase of the rotary tool;

FIG. 11D is a diagram illustrating a relationship among the number of blades of a rotary tool, a rotation speed ratio, and a phase of the rotary tool;

FIG. 12A is another diagram illustrating a relationship among the number of blades of a rotary tool, a rotation speed ratio, and a phase of the rotary tool;

FIG. 12B is another diagram illustrating a relationship among the number of blades of a rotary tool, a rotation speed ratio, and a phase of the rotary tool;

FIG. 12C is another diagram illustrating a relationship among the number of blades of a rotary tool, a rotation speed ratio, and a phase of the rotary tool;

FIG. 12D is another diagram illustrating a relationship among the number of blades of a rotary tool, a rotation speed ratio, and a phase of the rotary tool; and

FIG. 13 is a block diagram illustrating still another embodiment of the machining assistance apparatus in the present disclosure.

### MODE(S) FOR CARRYING OUT THE INVENTION

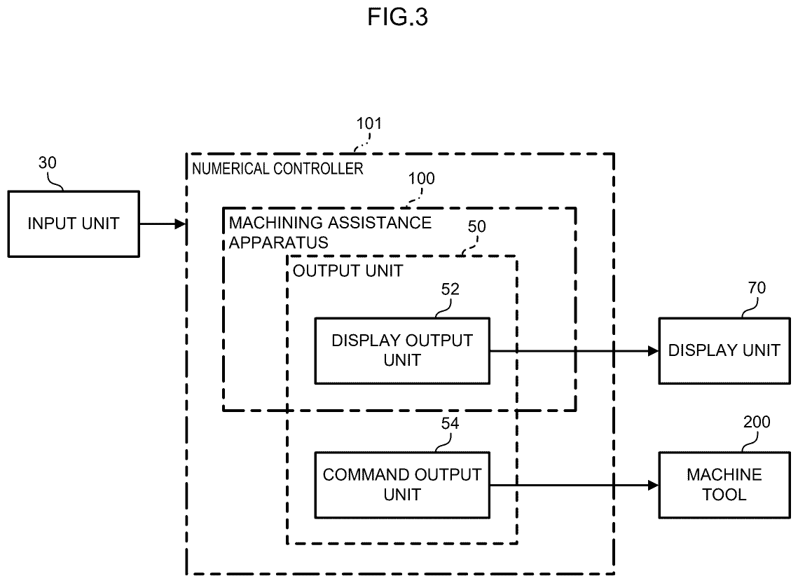

Hereinafter, an embodiment of a machining assistance apparatus 100 having a polygon machining assistance function for a workpiece will be illustrated below. The machining assistance apparatus 100 described in this application is an apparatus that can calculate various data related to machining processing of a machine tool that cuts a workpiece into a polygon shape by rotating the workpiece and a tool at a constant ratio. Note that the machining assistance apparatus 100 may be understood to be mounted in a numerical controller 101 used to control numerical values such as the amount of movement and a movement speed of a tool when a machine tool 200 machines a workpiece, and included in a part of the numerical controller 101 (see FIG. 3 and an exposition with reference to the Figure to be given later).

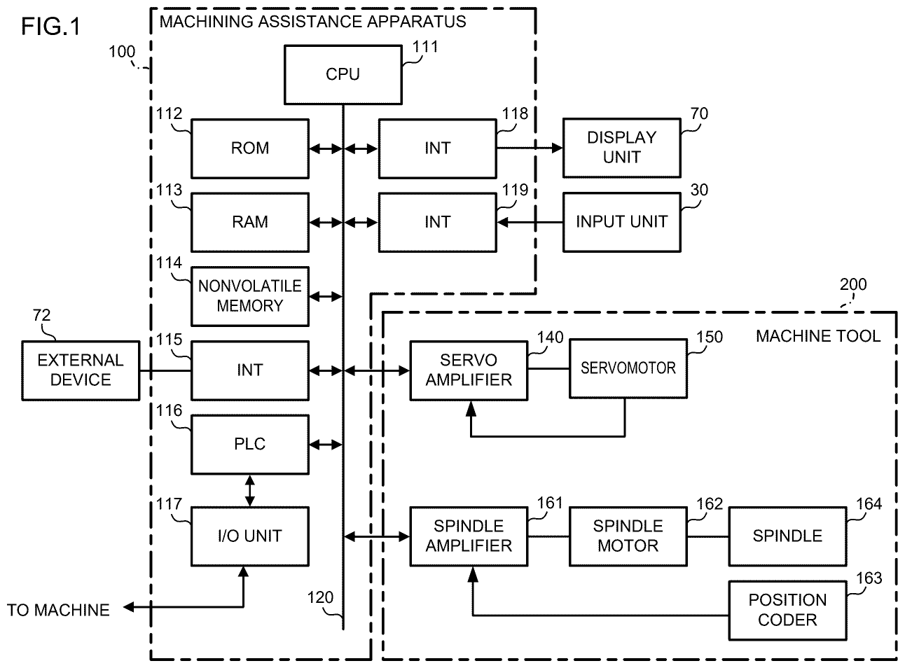

As illustrated in FIG. 1, the machining assistance apparatus 100 includes a CPU (central processing unit) 111 for controlling the entire machining assistance apparatus 100, a ROM (read only memory) 112 for recording programs and data, and a RAM (random access memory) 113 that can temporarily load data. The machining assistance apparatus 100 further includes a bus 120 for serving as a transmission path for transmitting signals, data, etc. within the apparatus, and the CPU 111, ROM 112, and RAM 113 are interconnected via the bus 120. The CPU 111 reads a system program recorded in the ROM 112 via the bus 120, and controls the entire machining assistance apparatus 100 in accordance with the system program.

The machining assistance apparatus 100 further includes a nonvolatile memory 114, which is also connected to other internal components via the bus 120. The nonvolatile memory 114 is backed up by, for example, a battery, not illustrated, so that a storage state is maintained even when the power to the machining assistance apparatus 100 is turned off.

The nonvolatile memory 114 stores various information acquired from respective components in the machining assistance apparatus 100 and from another device connected to the machining assistance apparatus 100. Examples of information acquired from components in the machining assistance apparatus 100 and stored in the nonvolatile memory 114 include various data such as setting parameters and sensor information. Furthermore, examples of information acquired from another device connected to the machining assistance apparatus 100 and stored in the nonvolatile memory 114 include a program read from an external device 72 via an interface 115, a user operation which is input to the machining assistance apparatus 100 via an interface 119 by an operation of an input unit 30 by an operator, and various data such as setting parameters and sensor information acquired from the machine tool 200.

The interface 115 serves to connect the machining assistance apparatus 100 to the external device 72 such as an adapter. Information such as programs and various parameters is read to the machining assistance apparatus 100 from the external device 72. Furthermore, information such as programs and various parameters edited in the machining assistance apparatus 100 can be stored in an external storage means via the external device 72.

The machining assistance apparatus 100 further includes a PLC 116 (programmable logic controller) and an I/O unit 117. The PLC 116 performs a control operation by inputting or outputting a signal via the I/O unit 117 between the PLC 116 and a device such as the machine tool 200, a robot, or a sensor attached to the machine tool 200 or the robot, by means of a sequence program incorporated in the machining assistance apparatus 100.

The machining assistance apparatus 100 is connected to a display unit 70 via an interface 118. With such a connection, an operation screen of the machine tool 200, a display screen indicating an operating state of the machine tool 200, et cetera, are displayed on the display unit 70.

The input unit 30 includes an MDI (manual data input), an operation panel, a touch panel, et cetera, and transmits operation input by the operator to the CPU 111.

The machining assistance apparatus 100 is connected to a servo amplifier 140 for controlling each axis of the machine tool 200. The servo amplifier 140 is connected to a servomotor 150 of the machine tool 200 to drive the servomotor 150 upon receiving a movement command amount of the axis from the CPU 111. The servomotor 150 incorporates a position/speed detector, feeds back a position/speed feedback signal from this position/speed detector to the servo amplifier 140, and performs position/speed feedback control. A tool axis is attached to the servomotor 150. A tool T for performing polygon machining, so to speak, a blade is attached to the body of a tool.

The machining assistance apparatus 100 is further connected to a spindle amplifier 161 for controlling a spindle 164 of the machine tool 200 to which a workpiece W can be attached. The spindle amplifier 161 is connected to a spindle motor 162 in the machine tool 200, receives a spindle rotation command to the spindle 164 of the machine tool 200, and drives the spindle motor 162. In the machine tool 200, the power of the spindle motor 162 is transmitted to the spindle 164 via gears, and the spindle 164 rotates at a commanded rotation speed.

A position coder 163 is coupled to the spindle 164, and the position coder 163 is further connected to the spindle amplifier 161 in the machining assistance apparatus 100. With this connection configuration, the position coder 163 outputs a feedback pulse to the spindle amplifier 161 in synchronization with rotation of the spindle 164, and the feedback pulse is read by the CPU 111 via the bus 120.

During polygon machining of the workpiece, the workpiece W is attached to the spindle 164. Axial directions of the spindle 164 and the tool shaft are parallel to each other, and the spindle 164 and the tool axis rotate at a predetermined rotation ratio. When the spindle 164 and the tool axis simultaneously rotate, the tool T attached to the tool axis cuts a surface of the workpiece. Then, a polygon is formed on the workpiece surface.

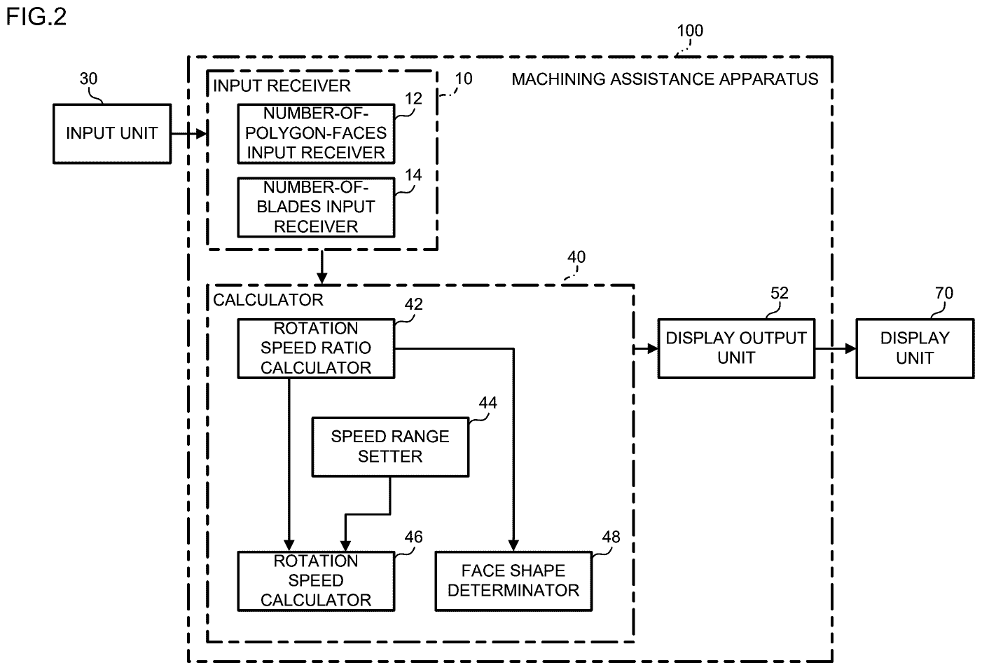

FIG. 2 is a block diagram of the machining assistance apparatus 100 that has polygon machining assistance functions for a workpiece. The functions in this block diagram are actualized by the CPU 111 executing a program recorded in a storage device such as the ROM 112. A functional configuration example of the machining assistance apparatus 100 illustrated in the block diagram of FIG. 2 may be a basic aspect of the invention.

The machining assistance apparatus 100 includes an input receiver 10 for executing an input reception process of information related to polygon machining processing of a workpiece received from the input unit 30 connected to the machining assistance apparatus 100. Information is transmitted from the input unit 30 to the input receiver 10 by, for example, an operation of the input unit by an operator.

The input receiver 10 includes a number-of-polygon-faces input receiver 12 for receiving information related to a machined shape of a workpiece formed by cutting, that is, the number of polygon faces. The input receiver 10 in this aspect further includes a number-of-blades input receiver 14 for receiving information related to the number of blades attached to a tool used in polygon machining.

Furthermore, it is more preferable that the input receiver 10 is configured to be able to receive input of information related to detection results obtained from various sensors provided in the machine tool 200.

The machining assistance apparatus 100 further includes a calculator 40 for calculating various data related to assistance of polygon machining with respect to a workpiece. The calculator 40 is functionally connected to the input receiver 10, and can use information, input of which is received by the input receiver 10, for data calculation as necessary. The calculator 40 has a rotation speed ratio calculator 42 for calculating a rotation speed ratio of the rotary tool to the number of polygon faces of the workpiece to be machined during polygon machining.

A data calculation function by the calculator 40 is actualized by an in-device control element such as the CPU 111 illustrated in FIG. 1, storage elements such as the ROM 112, the RAM 113, and the nonvolatile memory 114, or both the in-device control element and the in-device storage elements. For example, the rotation speed ratio may be calculated by inputting the desired number of polygon faces for the workpiece to be machined and the number of blades of the rotary tool to be used during machining by the operator, and performing computation by the CPU 111 based on this input information. Alternatively, referring to calculation of the rotation speed ratio, by inputting the desired number of polygon faces by the operator while receiving supply of the number of blades of the rotary tool to be used from the machine tool 200 connected to the machining assistance apparatus 100, the rotation speed ratio may be computed by the CPU 111 based on input information obtained in this way.

Alternatively, in order to derive an appropriate rotation speed ratio, a combination of the number of blades of the rotary tool and the rotation speed ratio for actualizing the number of polygon faces that is input from the input unit 30 may be stored in the ROM 112 in advance. In this case, when the machining assistance apparatus 100 acquires information related to the desired number of polygon faces and number of blades, the rotation speed ratio calculator 42 selects the corresponding rotation speed ratio based on the combination of the number of blades of the rotary tool and the rotation speed ratio stored in the ROM 112.

Note that the rotation speed ratio calculator 42 can determine that it is impossible to calculate an appropriate rotation speed ratio, that is, that polygon machining is impossible under the input conditions of the number of polygon faces and the number of blades. Therefore, the rotation speed ratio calculator 42 functions, in a sense, as a determinator for determining whether or not polygon machining is possible to determine that desired polygon machining is possible when a rotation speed ratio can be calculated and to determine that desired polygon machining is impossible when a rotation speed ratio cannot be calculated.

Here, an example of a method of calculating a ratio of a tool rotation speed to the number of polygon faces will be described. As illustrated in Table 1, the number of polygon faces of a workpiece after machining, that is, the number of corners of a polygon that forms a shape of the workpiece after machining, can be calculated by multiplying a rotation speed ratio by the number of blades attached to a rotary tool. That is, the rotation speed ratio can be calculated by a quotient of polygon shape/number of blades.

TABLE 1

| | | | | | |
|---|---|---|---|---|---|
| Ratio of tool | 1 | 2 | 3 | 4 | 5 |
| rotation speed | | | | | |
| to workpiece | | | | | |
| Number of blades | 3 | 3 | 3 | 3 | 3 |
| Polygon shape | Triangle | Hexagon | Nonagon | Do- | Quin- |
| | | | | decagon | decagon |

| | | | | | |
|---|---|---|---|---|---|
| Ratio of tool | 2 | 3 | 4 | 1.5 | 2.5 |
| rotation speed | | | | | |
| to workpiece | | | | | |
| Number of blades | 2 | 2 | 2 | 2 | 2 |
| Polygon shape | Tetragon | Hexagon | Octagon | Triangle | Pentagon |

| | | |
|---|---|---|
| Ratio of tool | 2 | 1 |
| rotation speed | | |
| to workpiece | | |
| Number of blades | 5 | 5 |
| Polygon shape | Decagon | Pentagon |

The machining assistance apparatus 100 may calculate a combination of a rotation speed ratio, the number of blades, and a polygon shape in advance and store the calculated combination in hardware such as the ROM 112. In this case, when the operator inputs the desired number of polygon faces and the number of blades of the rotary tool to be used via the input unit 30, the rotation speed ratio calculator 42, which includes a storage device such as the ROM 112 as a part of components, selects a rotation speed ratio corresponding to an input value based on a stored calculation result, and executes subsequent processings using the selected rotation speed ratio as a calculation ratio of a rotation speed.

Alternatively, the machining assistance apparatus 100 may calculate the rotation speed ratio by performing computation based on input data each time the number of polygon faces and the number of blades are input.

The machining assistance apparatus 100 includes a speed range setter 44 for presetting a numerical range of an axis rotation speed that can be taken by the rotary tool and the workpiece, and records the set range. The rotation speed range may be set based on operator input or based on information supplied from the machine tool 200 side that includes a rotary tool axis and a workpiece rotary axis. The numerical range, which is set as the rotation speed range that can be taken by the rotary tool axis and the workpiece rotary axis, is registered in the speed range setter 44. The rotation speed range is determined, for example, by structural or functional constraints of the machine tool 200. Further, as the rotation speed range to be set, a recommended cutting speed or a range thereof depending on the material of the workpiece or the model of the tool may be registered in advance in the speed range setter 44. The model of the tool mentioned herein may include, for example, the number of blades attached to the tool, a radius of rotation of the tool, and any other information related to a structure of the tool.

The calculator 40 includes a rotation speed calculator 46 for calculating axis rotation speeds of the rotary tool axis and the workpiece rotary axis within the set speed range of the rotary tool axis and the workpiece rotary axis which are registered in the speed range setter 44 based on the rotation speed ratio calculated by the rotation speed ratio calculator 42.

Note that the rotation speed calculator 46 may be able to calculate a plurality of candidates for each numerical value that can be taken as the rotation speed of each of the rotary tool axis and the workpiece rotary axis during polygon machining. In this case, the rotation speed calculator 46 may select an optimal rotation speed from the plurality of candidates and determine the optimal rotation speed as the rotation speed of each axis. Alternatively, the rotation speed calculator 46 may provide all of the calculated candidates as rotation speed candidate data to a display output unit 52 described below.

Note that, as described above, as illustrated in FIG. 3, the machining assistance apparatus 100 can be installed in the numerical controller 101 as a part of components of the numerical controller 101. The numerical controller 101 includes a command output unit 54, which is connected to the machine tool 200, generates a command signal for commanding the machine tool 200 to execute a predetermined operation to output the generated command signal to the machine tool 200, especially the servomotor 150 and the spindle motor 162. The display output unit 52 of the machining assistance apparatus 100 and the command output unit 54 in the numerical controller 101 can be regarded as an output unit 50 included in the numerical controller 101 in a broad sense. The output unit 50 can be regarded as a unit for performing control processing related to generation of a control signal for connected devices and output of a generated signal in order to appropriately operate devices such as the display unit 70 and the machine tool 200 connected to the numerical controller 101 including the machining assistance apparatus 100.

The machine tool 200 receiving a command signal from the command output unit 54 operates according to a command included in the signal. When the operator inputs an instruction related to adjustment of polygon machining via the input unit 30 taking into consideration display content of the display unit 70, the command output unit 54 can generate an adjustment command signal to adjust an operation of the machine tool 200, and adjust an operation of the machine tool 200 based on information content of the adjustment command signal.

The output unit 50 in a broad sense is connected to the calculator 40 in the machining assistance apparatus 100, and can receive calculation data related to a rotation speed ratio calculated by the rotation speed ratio calculator 42 and a rotation speed calculated by the rotation speed calculator 46 from the calculator 40.

As mentioned above, in particular, the machining assistance apparatus 100 includes the display output unit 52 for generating a display control signal to control a display operation of the display unit 70 based on calculation results related to the rotation speed ratio and the rotation speed received from the calculator 40, and outputs the generated signal to the display unit 70. According to such a connection configuration relationship, whether or not polygon machining is possible under a condition input by the operator, a rotation speed ratio between the workpiece and the rotary tool, and a calculation result such as a rotation speed of each of the workpiece and the rotary tool according to the rotation speed ratio are displayed on a display screen included in the display unit 70. By looking at the display screen of the display unit 70, the operator can check a polygon machining process performed by the machine tool 200 on the workpiece, and can perform desired adjustment via the input unit 30 as necessary.

When receiving a plurality of pieces of data as candidates for a rotation speed of each of the rotary tool axis and the workpiece rotary axis from the rotation speed calculator 46, the display output unit 52 can cause the display unit 70 to display all or a part of the plurality of pieces of received candidate data. In this case, the operator can select an axis rotation speed determined to be optimal from the plurality of pieces of candidate data displayed on the display screen of the display unit 70, and perform desired adjustment for the polygon machining through an operation of the input unit 30.

Note that, when a recommended cutting speed is registered in the speed range setter 44, the rotation speed calculator 46 may calculate the axis rotation speed under a condition that the recommended cutting speed is satisfied. Alternatively, the rotation speed calculator 46 may calculate, as candidate data, not only the axis rotation speed satisfying the recommended cutting speed but also an axis rotation speed that is not the recommended cutting speed but is within the set rotation speed range. In this case, it is preferable that the rotation speed calculator 46 adds information related to whether or not each piece of candidate data has a recommended cutting speed and supplies the information to the display output unit 52. The display output unit 52 may cause the display unit 70 to output each piece of candidate data for a rotation speed received from the rotation speed calculator 46 together with displaying information as to whether or not a cutting speed is the recommended cutting speed.

By using the machining assistance apparatus 100 including the above-described configuration, the operator can create a polygon machining program without mistakes, and a burden on the operator during creation can be reduced. Furthermore, with the assistance of this apparatus, the operator can verify in advance whether or not machining into a desired polygon shape is possible using a tool or a machine that is owned.

Incidentally, when a workpiece is cut into a polygon shape by rotating the workpiece and the rotary tool at a certain ratio, there are a case where each face of the workpiece is formed to bulge and a case where each face of the workpiece is formed to dent depending on the machining conditions. For this reason, it is preferable that the calculator 40 in the machining assistance apparatus 100 includes a face shape determinator 48 for determining a face shape as to whether each surface of the workpiece subjected to polygon machining under a predetermined condition bulges or dents.

As an example of a method of determining whether a shape of each face of the workpiece due to polygon machining is a concave or convex shape, the shape is determined according to the rotation speed ratio between the workpiece and the rotary tool and the number of blades of the rotary tool. For example, when the number of blades attached to the rotary tool is 3:
the workpiece surface has a convex shape if the rotation speed ratio <the number of blades, and
the workpiece surface has a concave shape if the rotation speed ratio >the number of blades. Meanwhile, when the number of blades attached to the rotary tool is 2:
the workpiece surface has a convex shape if the rotation speed ratio≤the number of blades, and
the workpiece surface has a concave shape if the rotation speed ratio >the number of blades.

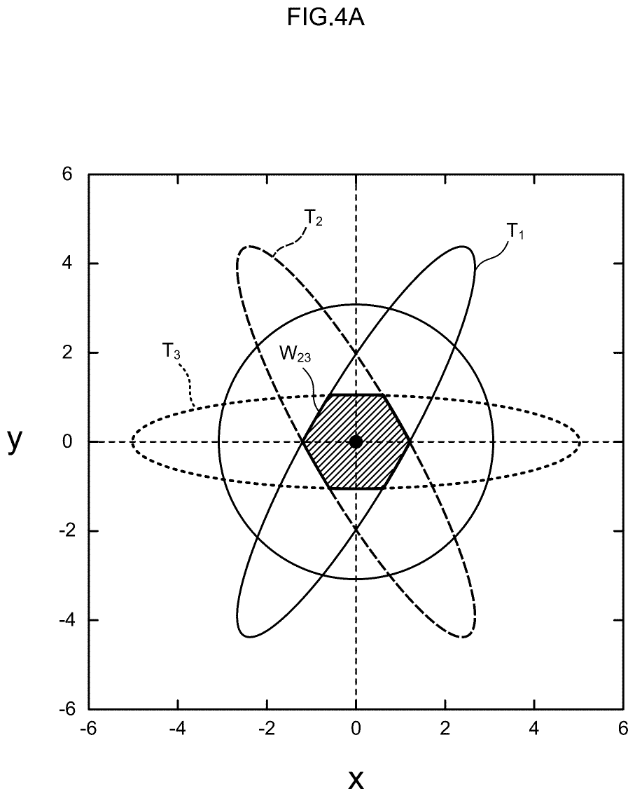

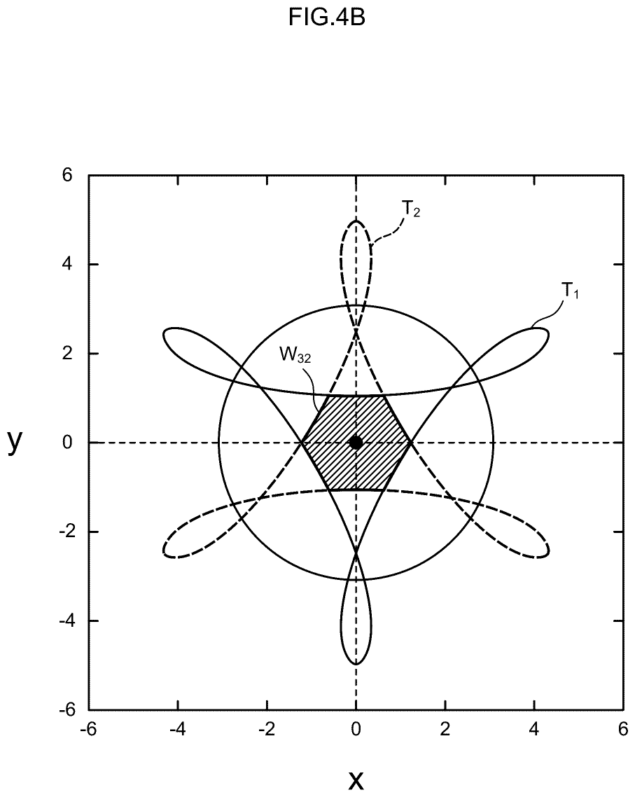

FIG. 4 illustrates an example of a correspondence relationship among the rotation speed ratio between the workpiece and the rotary tool, the number of blades of the rotary tool, and the shape of the workpiece surface. In both FIGS. 4A and 4B, the shape of the workpiece W formed by polygon machining is still a hexagon. However, in the case of machining illustrated in FIG. 4A, where a ratio of a tool rotation speed to a workpiece W₂₃ is 2 and the number of blades of the tool is 3 (trajectories of the respective blades: T₁, T₂, and T₃), each face of the hexagonal shape has a slight bulge. On the other hand, in the case of machining illustrated in FIG. 4B, where a ratio of a tool rotation speed to a workpiece W₃₂ is 3 and the number of blades of the tool is 2 (trajectories of the respective blades: T₁ and T₂), each face of the hexagonal shape slightly dents.

The face shape determinator 48 can determine whether the shape of each face of the workpiece formed by polygon machining bulges in a convex shape or dents in a concave shape based on information related to the number of blades obtained, for instance, via the number-of-blades input receiver 14, and a rotation speed ratio calculated by the rotation speed ratio calculator 42.

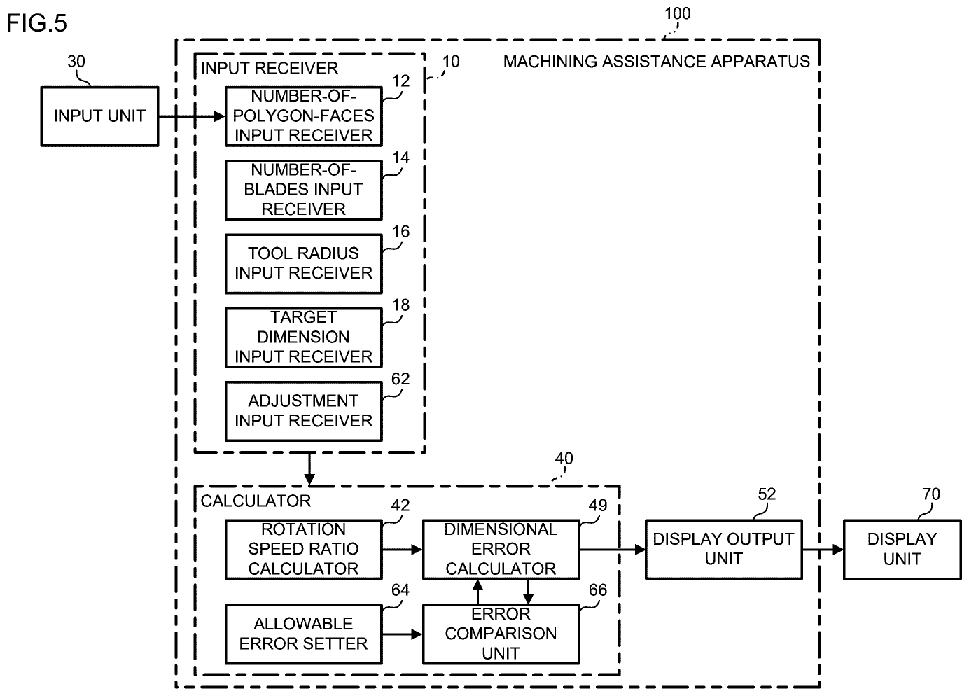

Next, another embodiment of the invention will be described with reference to FIGS. 5 to 7. In this aspect, it is possible to calculate a difference between the dimension of a workpiece to be targeted and the dimension of an actually formed workpiece in polygon machining, so-called a dimensional error.

A functional configuration of the present embodiment is generally similar to that of the aspect of the machining assistance apparatus 100 illustrated in FIG. 2. However, the input receiver 10 and calculator 40 have configurations unique to this aspect. In the following, this aspect will be specifically described with reference to FIG. 5, which is a block diagram illustrating the functional configuration of this aspect. However, illustration and description of a component common to the previous aspect illustrated in FIG. 2, among components included in the apparatus of this aspect, are intentionally omitted to avoid redundant expressions or duplicate descriptions.

As illustrated in FIG. 5, the input receiver 10 included in the machining assistance apparatus 100 according to the present embodiment includes a tool radius input receiver 16 for receiving input of information related to a radius (rₜ) of the rotary tool used in polygon machining on the workpiece, in addition to the number-of-polygon-faces input receiver 12 and the number-of-blades input receiver 14. The input receiver 10 further includes a target dimension input receiver 18 for receiving input of information related to a target dimension of the workpiece to be subjected to polygon machining. The machining assistance apparatus 100 can use the input radius (rₜ) of the rotary tool and the target dimension of the workpiece to calculate the dimensional error.

Note that a radius (r_{w}) of an inscribed circle of a polygon, which is an external shape of the workpiece W after polygon machining, can be set as the target dimension of the workpiece. Furthermore, at an input stage, input of a diameter of the inscribed circle of the polygon, which is the external shape of the workpiece W, may be received, and the radius r_{w} of the inscribed circle may be acquired through a calculation process by the calculator 40.

The calculator 40 included in the machining assistance apparatus 100 according to the present embodiment includes a dimensional error calculator 49 for calculating the dimensional error of the workpiece based on a predetermined calculation method. As for the calculation method, for example, a calculation formula can be stored in advance in a storage device such as the ROM 112.

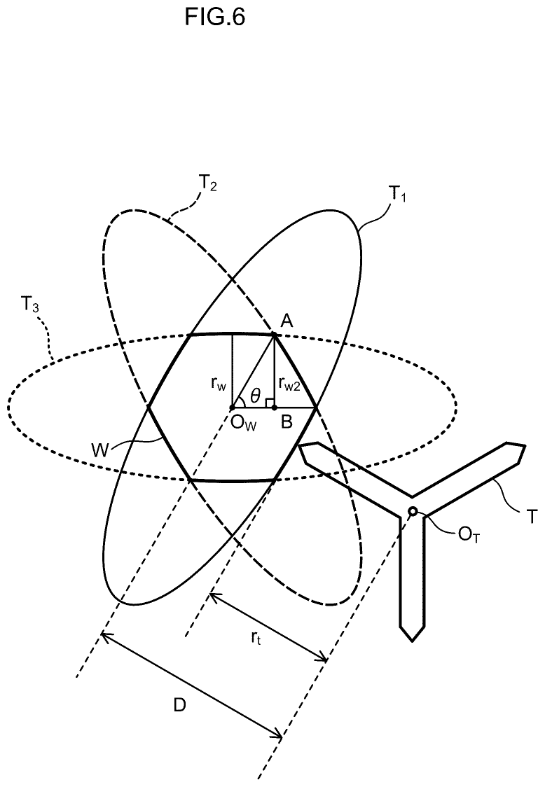

The dimensional error can be calculated using numerical data related to the radius r_{w} of the inscribed circle serving as the target dimension, the radius rₜ of the rotary tool, and the number n of polygon faces (n=6 in the case of FIG. 6 since the shape is a hexagon) received by the input receiver 10, and the rotation speed ratio (sr) calculated by the rotation speed ratio calculator 42. For example, the calculation formula can be calculated using the following formula.

$${r}_{w} - ( D \times sin ( - θ ) + {r}_{t} \times sin ( ( sr - 1 ) \times θ ) ) \qquad ( 1 )$$

### Here,

D: a distance between the center (O_{T}) of the rotary tool and the center (O_{w}) of the workpiece subjected to polygon machining

θ: 360/n

In this formula, when a calculation result of (D×sin (−θ)+rₜ×sin ((sr−1)×θ)) is described with reference to FIG. 6, the calculation result corresponds to the length of an opposite side r_{w2} of an angle θ in a right triangle, vertices of which are the center O_{w} of the workpiece, one end A of the workpiece surface in contact with the inscribed circle radius r_{w}, and B which is the vertex of a right angle.

It is obvious that the method of calculating the dimensional error is not limited to the calculation formula (1) described above. The dimensional error may be derived using other known calculation methods or improved calculation methods.

The dimensional error calculator 49 is connected to the display output unit 52, and the calculation result of the dimensional error by the dimensional error calculator 49 is supplied to the display output unit 52. The display output unit 52 performs output control for causing the display unit 70 to display the calculation result of the dimensional error.

In the present embodiment, it is preferable that the machining assistance apparatus 100 is further provided with a component that can assist adjustment of an error when adjustment to reduce the dimensional error calculated by the dimensional error calculator 49 is required. Since FIG. 5 illustrates components provided in a more preferred example of the present embodiment, a more preferred aspect will be described in detail below with reference to the Figure.

It is preferable that the input receiver 10 includes an adjustment input receiver 62 for receiving a dimensional error adjustment command through an operation of the input unit 30 by the operator. As described above, a calculated value of the dimensional error calculated by the dimensional error calculator 49 is displayed on the display unit 70. For this reason, when the operator checks the calculated value of the dimensional error displayed on the display unit 70, and determines that the checked value is excessive for the dimensional error, the operator can request the machining assistance apparatus 100 to recalculate the dimensional error by adjusting a machining condition and further output the recalculated dimensional error by an operation of the input unit 30. When the adjustment input receiver 62 receives a dimensional error adjustment command via the input unit 30, the receiver 62 transmits an adjustment command signal requesting the dimensional error calculator 49 to adjust the machining condition and recalculate the dimensional error.

The machining assistance apparatus 100 may include, together with or in place of the adjustment input receiver 62, an allowable error setter 64 setting how much dimensional error is allowed during polygon machining. For example, the allowable error setter 64 can be actualized by means of hardware such as the CPU 111 and the ROM 112 as components of the calculator 40.

The allowable dimensional error may be set based on advance input by the operator. Alternatively, referring to setting of the allowable dimensional error, the allowable error setter 64 may calculate a set value based on information related to the rotary tool used in polygon machining, the polygon shape to be formed, the rotation speeds of the workpiece and the tool, and so on, the information is acquired from the machine tool 200.

The calculator 40 preferably includes an error comparison unit 66 which is connected to the allowable error setter 64 and also connected to the dimensional error calculator 49 so that mutual communication is possible, the allowable error setter comparing a numerical value of the dimensional error calculated by the dimensional error calculator 49 with a set value of the allowable dimensional error registered in the allowable error setter 64. When the error comparison unit 66 determines that the dimensional error calculated by the dimensional error calculator 49 exceeds the allowable dimensional error as a result of comparison, the comparison unit 66 notifies to the dimensional error calculator 49 the determination result that the dimensional error needs to be reduced.

When an adjustment command signal is received from the adjustment input receiver 62, or when a notification signal of a determination result that the calculated dimensional error exceeds the allowable dimensional error is received from the error comparison unit 66, the dimensional error calculator 49 changes a polygon machining condition used to calculate the dimensional error and recalculate the dimensional error. The polygon machining condition changed to derive a recalculated value of the dimensional error is, for example, a distance D between the center (O_{T}) of the rotary tool and the center (O_{w}) of the workpiece subjected to the polygon machining, or the rotation speed of the rotary tool.

After recalculating the dimensional error after adjustment, the dimensional error calculator 49 supplies information related to the calculated dimensional error after adjustment to the display output unit 52. The dimensional error after adjustment and information related thereto are displayed on the display unit 70 by output control with respect to the display unit 70 processed by the display output unit 52. The operator can check the dimensional error and so on after adjustment displayed on the display unit 70, and thus may input a command to start execution of polygon machining based on a display result, or may input a request for further adjustment of the dimensional error to the machining assistance apparatus 100.

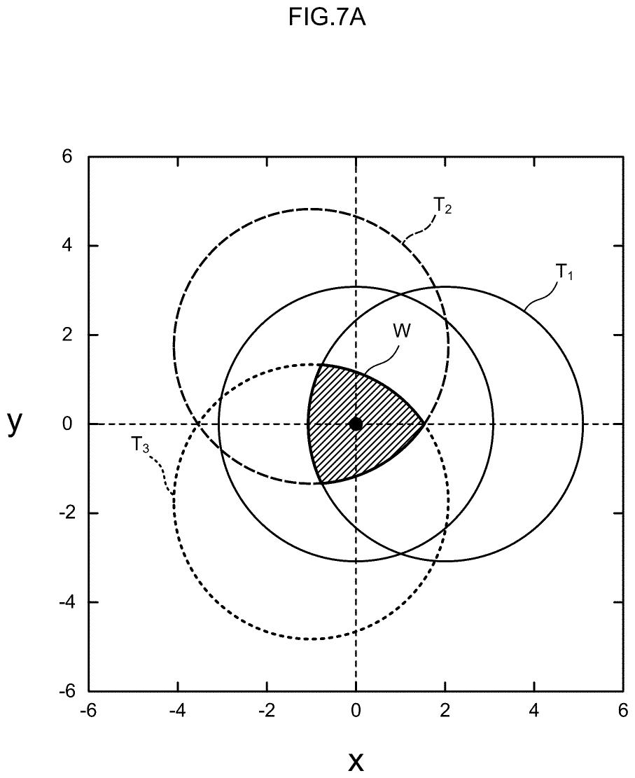

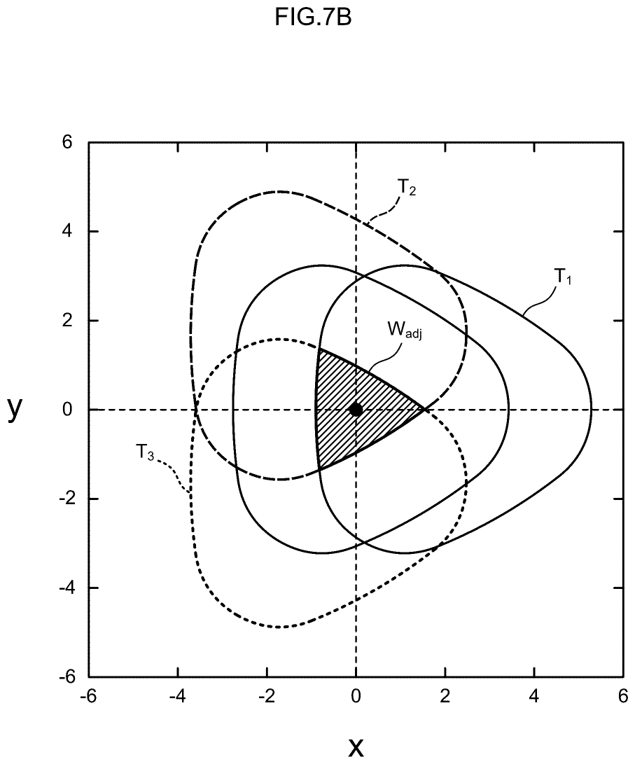

Examples of polygon machining states of the workpiece before and after adjusting the dimensional error displayed on the display unit 70 are illustrated in FIG. 7. In the Figure, FIG. 7A is a diagram illustrating cutting trajectories (T₁, T₂, and T₃) of the tool before adjusting the dimensional error and a polygon shape of the workpiece W to be formed, and FIG. 7B is a diagram illustrating cutting trajectories (T₁, T₂, and T₃) of the tool after adjusting the dimensional error and a polygon shape of a workpiece W_{adj} to be formed.

Polygon machining displayed in the example of FIG. 7 is machining when the rotation speed ratio is set to 1 and the number of blades of the rotary tool is 3. That is, as illustrated in FIG. 7A, in such polygon machining, the workpiece W having a triangular shape, in which each face has a bulge, is formed.

Under a setting condition that the distance D between the center (O_{T}) of the rotary tool and the center (O_{w}) of the workpiece subjected to polygon machining varies, the dimensional error calculator 49 can recalculate the dimensional error using the above calculation formula (1) or the like, that is, can adjust the dimensional error. Information related to the dimensional error after adjustment is also displayed via the display output unit 52 on the display unit 70 as illustrated in FIG. 7B. As is clear from comparison of display screens of FIG. 7A and FIG. 7B, a surface shape of the workpiece after machining under the condition that the distance D is varied to adjust and reduce the dimensional error is machined to be as flat as possible compared to the shape before adjustment, in other words, not to have unevenness as possible.

When the operator determines an optimal machining condition such as the distance D with the assistance of the machining assistance apparatus 100, a command for executing polygon machining under the machining condition can be input to the machining assistance apparatus 100 through the operation of the input unit 30. The machining assistance apparatus 100 receiving the input outputs information related to the determined machining condition to the command output unit 54, so that the information is reflected in polygon machining on the workpiece using the machine tool 200 under the control of the command output unit 54.

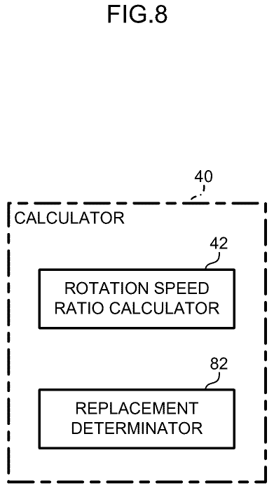

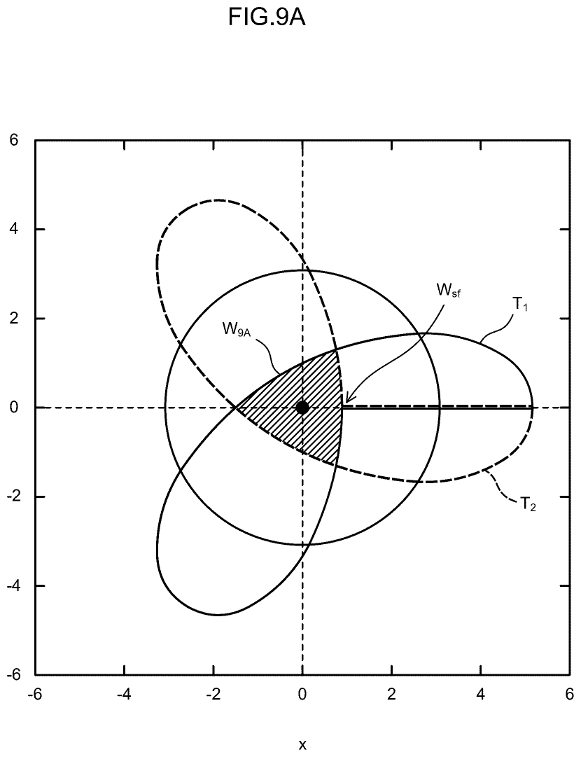

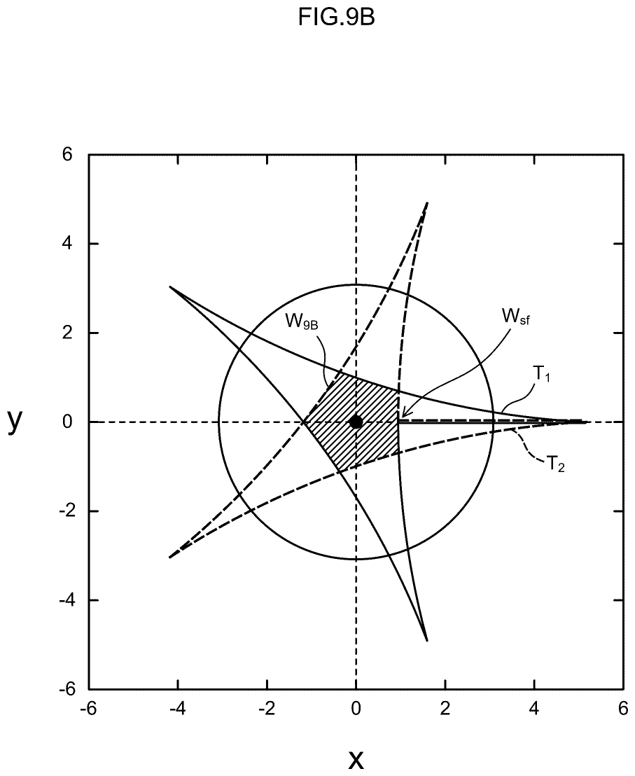

Next, still another embodiment of the invention will be described with reference to FIGS. 8 to 9. According to a machining assistance apparatus 100 of an aspect described below, various determinations or calculations related to the rotary tool during polygon machining can be performed.

FIG. 8 illustrates an example of a configuration of a calculator 40 in the machining assistance apparatus 100 according to this aspect. In the case of this aspect, configurations of the input receiver 10 and the output unit 50 may be the same as those in the aspect illustrated in FIG. 2, and thus duplicate illustration and description thereof will be omitted.

When executing polygon machining on a workpiece, if a rotation speed ratio of a rotary tool having a plurality of blades to a polygon is an integer multiple (2, 3, etc.), each face of the workpiece to be machined into a polygonal shape is cut using a single tool per face. However, when the rotation speed ratio of the rotary tool having the plurality of blades is not an integer multiple (1.5, 2.5, etc.), some faces may be cut using a plurality of tools. Cutting one face using a plurality of tools, more specifically, using a plurality of tools in which conditions such as tool lengths do not necessarily match, for example, due to different degrees of wear needs to be avoided from a viewpoint of achieving high-precision cutting. The machining assistance apparatus 100 having the calculator 40 illustrated in FIG. 8 can determine whether or not the tool for cutting each face of the workpiece is replaced every rotation for cutting of a certain face.

In addition to the rotation speed ratio calculator 42, the calculator 40 in this embodiment includes a replacement determinator 82 for determining whether or not the tool for cutting each face of the workpiece is replaced every rotation for cutting a certain face. After the calculator 40 receives data related to the number of blades of the rotary tool and the number of polygon faces to be machined from the input receiver 10 and calculates the rotation speed ratio by the rotation speed ratio calculator 42, the replacement determinator 82 in the calculator 40 receives information including the rotation speed ratio calculated by the rotation speed ratio calculator 42.

The replacement determinator 82 determines, based on the received rotation speed ratio, whether or not a blade of the tool cutting each face of the workpiece is replaced every rotation for cutting of a certain face. To give an example of a specific method of determining whether or not a tool has been replaced, when the rotation speed ratio of the tool to the polygon calculated by the rotation speed ratio calculator 42 is an integer, the replacement determinator 82 determines that each face of the workpiece is cut by a single blade among blades attached to the tool. On the other hand, when the rotation speed ratio is not an integer, the replacement determinator 82 determines that a cutting blade is replaced every rotation for cutting of a certain face.

When the replacement determinator 82 determines that a tool blade cutting of a certain face of the workpiece is replaced during polygon machining, the calculator 40 transmits a determination result to the display output unit 52. The display output unit 52 receiving the determination result that the blade has been replaced executes a process of causing the display unit 70 to display the determination result, in a sense, a process of notifying the operator of the determination result.

An example of displaying the determination result on the display unit 70 by the replacement determinator 82 is illustrated in FIG. 9. FIG. 9A is a display example when the number of blades attached to the rotary tool is 2, and a ratio of a tool rotation speed to a polygon is 1.5, that is, a triangular workpiece is formed. FIG. 9B is a display example when the number of blades attached to the rotary tool is 2, and a ratio of a tool rotation speed to a polygon is 2.5, that is, a pentagonal workpiece is formed.

When a cutting trajectory by a first blade is set to T₁, and a cutting trajectory by a second blade is set to T₂, it can be confirmed from the display screen of the display unit 70 that both a workpiece W_{9A} illustrated in FIG. 9A and a workpiece W_{9B} illustrated in FIG. 9B have faces (W_{sf}) formed by being cut by both the first and second blades.

The operator receiving notification related to a determination result via the display unit 70 can change a cutting condition (for example, change a tool used or change a rotation speed of the workpiece or the tool) so that a cutting blade does not have to be replaced as necessary.

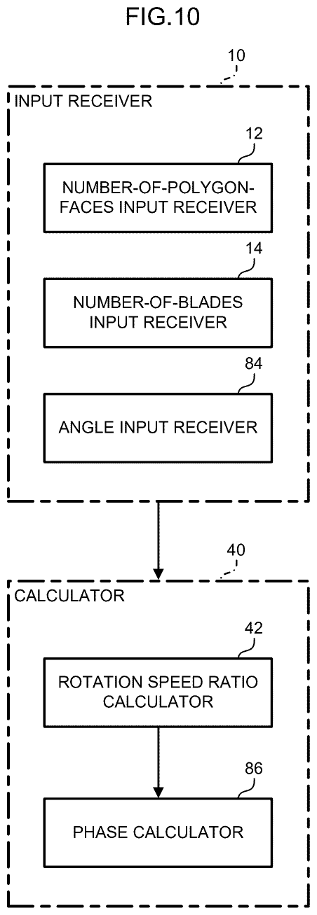

Further, FIG. 10 illustrates an example of configurations of an input receiver 10 and a calculator 40 in a machining assistance apparatus 100 according to this aspect. Note that the input receiver 10 and the calculator 40 may include components illustrated in FIG. 2 in addition to the components specifically illustrated in FIG. 10, and thus a functional configuration of the present embodiment is generally similar to that of the aspect of the machining assistance apparatus 100 illustrated in FIG. 2. However, configurations unique to this aspect are adopted in parts of the input receiver 10 and the calculator 40. In the following, this aspect will be specifically described with reference to FIG. 10, which is a block diagram illustrating the functional configuration of this aspect. However, illustration and description of components common to those in the previous aspect, among components included in the apparatus of this aspect, are intentionally omitted to avoid redundant expressions or duplicate descriptions.

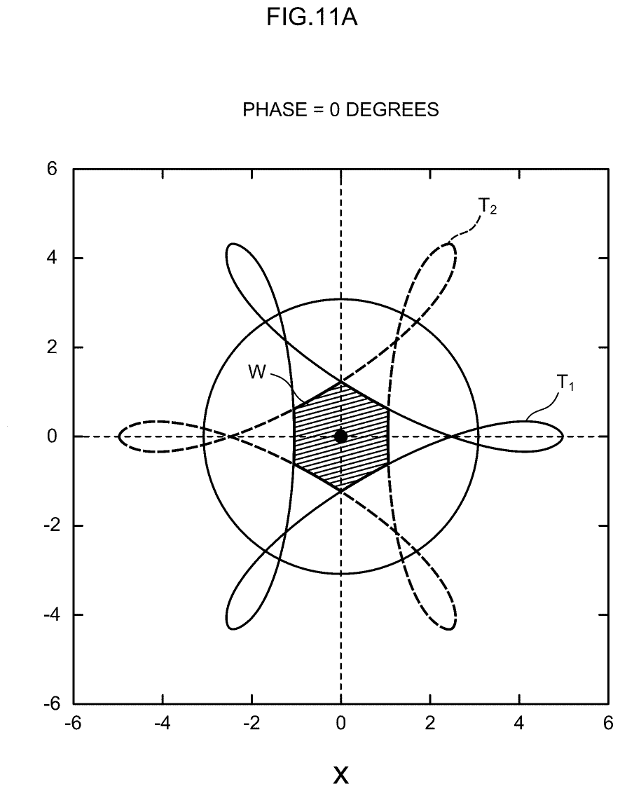

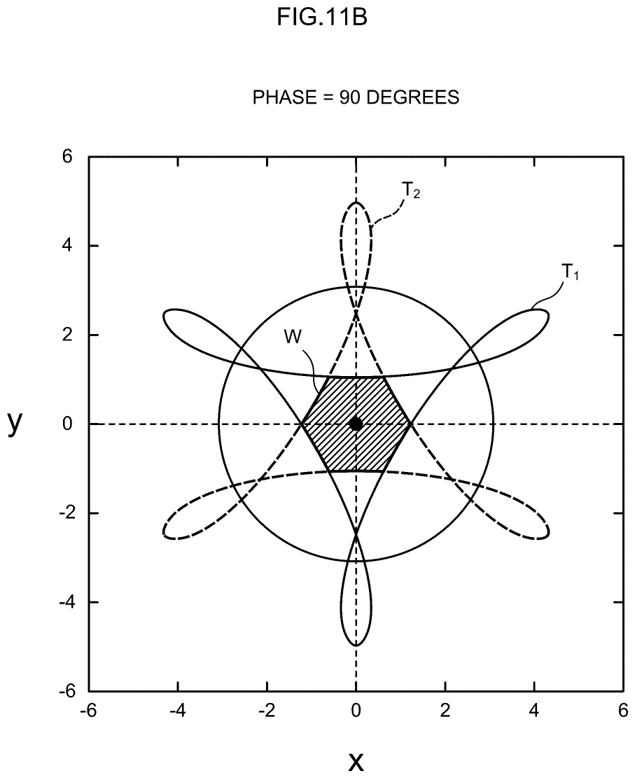

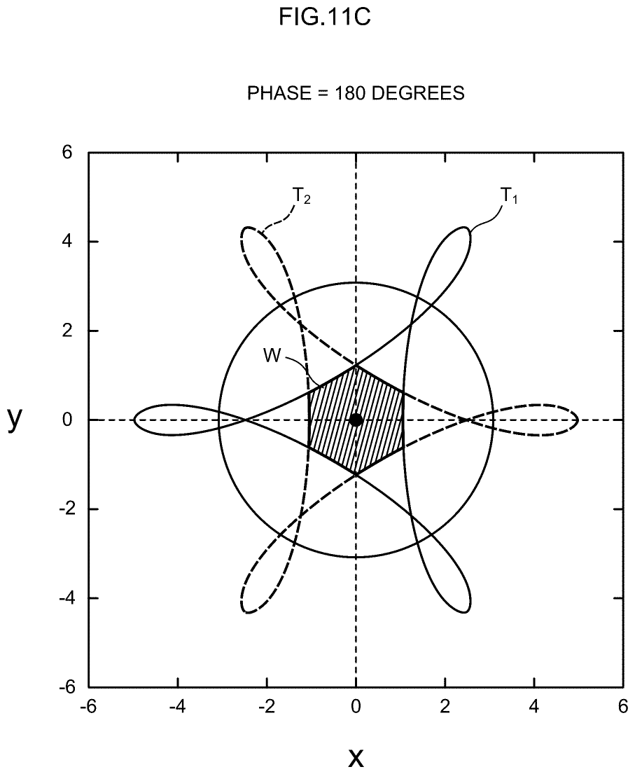

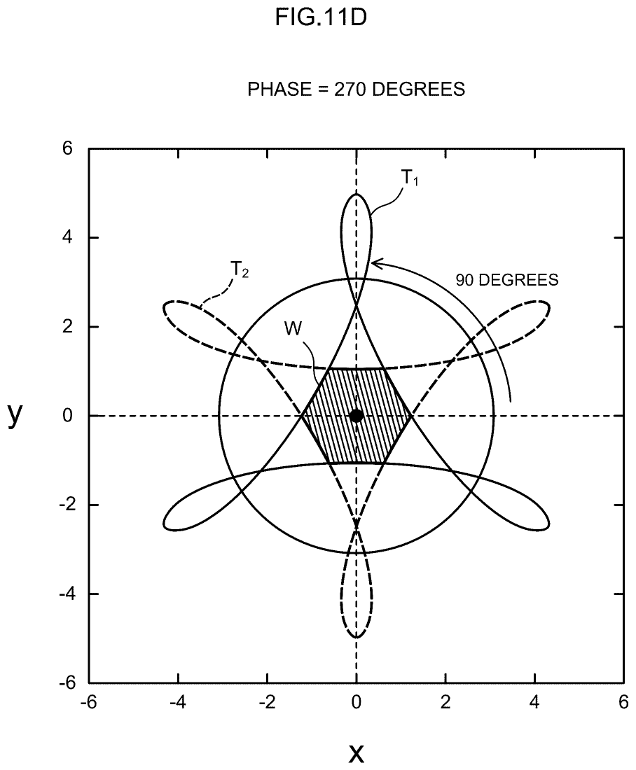

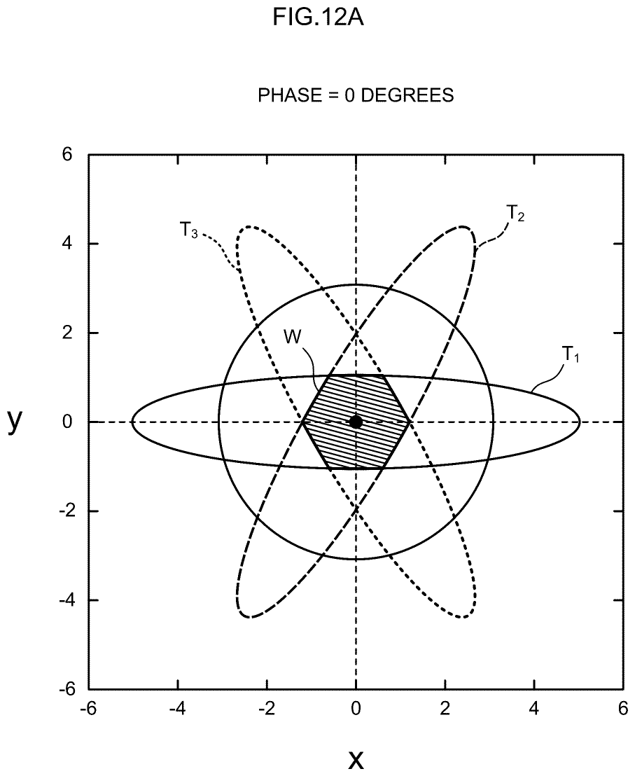

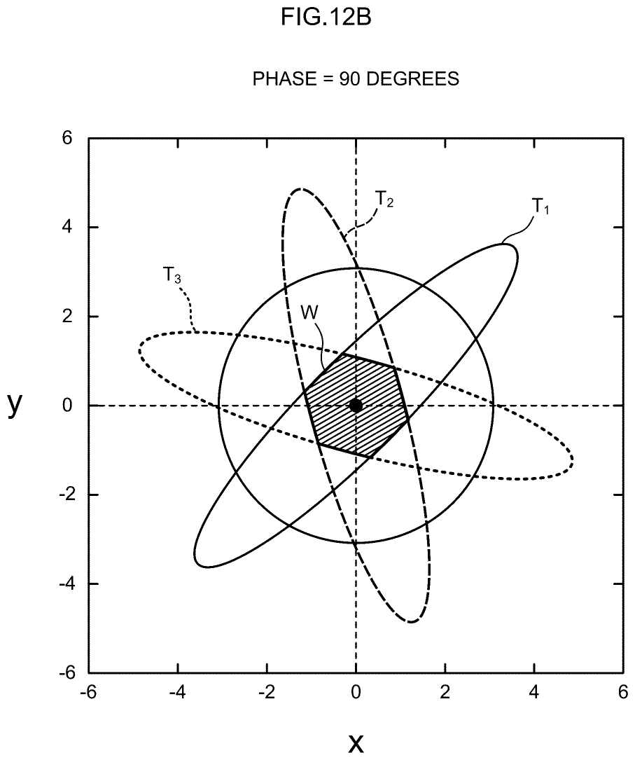

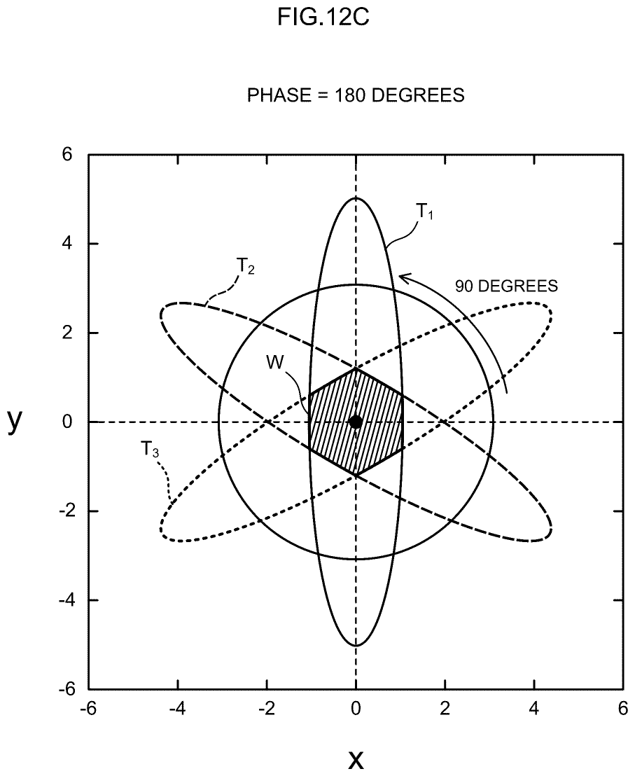

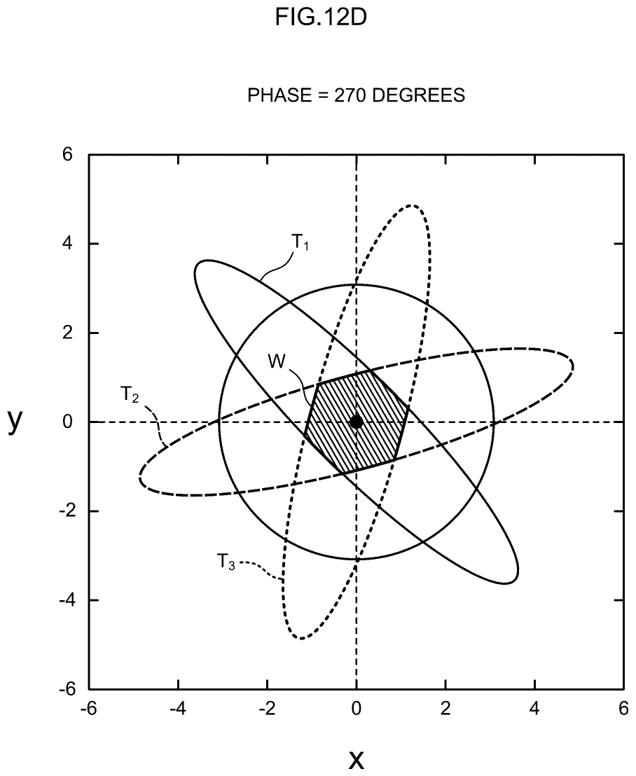

Incidentally, when polygon machining is executed on the workpiece, if the number of blades of the rotary tool or a rotation speed ratio with respect to a polygon is different, a rotation angle of the workpiece is different depending on each condition even when a phase of the rotary tool is the same, which will be described with reference to FIGS. 11 and 12. FIG. 11 illustrates an angle of the workpiece for each phase of the rotary tool when the number of blades attached to the rotary tool is 2 and a ratio of the tool rotation speed to the polygon is 3. On the other hand, FIG. 12 illustrates an angle of the workpiece for each phase of the rotary tool when the number of blades attached to the rotary tool is 3 and a ratio of the tool rotation speed to the polygon is 2.

FIG. 11A to FIG. 11D illustrate states of rotation angles of the workpiece at time points of phases 0 degrees, 90 degrees, 180 degrees, and 270 degrees when the number of blades of the rotary tool is 2 and the rotation speed ratio is 3. According to a series of diagrams, the workpiece during polygon machining rotates by 30 degrees each time the phase of the rotary tool changes by 90 degrees. As a result, the workpiece rotates by 90 degrees from an initial state when the phase of the rotary tool changes by 270 degrees.

FIG. 12A to FIG. 12D illustrate states of rotation angles of the workpiece at time points of phases 0 degrees, 90 degrees, 180 degrees, and 270 degrees when the number of blades of the rotary tool is 3 and the rotation speed ratio is 2. According to a series of diagrams, the workpiece during polygon machining rotates by 45 degrees each time the phase of the rotary tool changes by 90 degrees. As a result, the workpiece rotates by 90 degrees from an initial state when the phase of the rotary tool changes by 180 degrees.

A difference in the rotation angle of the workpiece at the same phase of the tool due to a difference in the number of blades of the rotary tool and the rotation speed ratio has an extremely important significance particularly when a cylindrical workpiece before polygon machining has an asymmetric shape with respect to a center line, for example, when one protrusion extends from a surface of a cylindrical workpiece before machining. The configuration example illustrated in FIG. 10 is particularly advantageous when such a workpiece is subjected to polygon machining.

The input receiver 10 in this example includes an angle input receiver 84 for receiving input related to designation on the rotation angle of the workpiece in response to an input operation of the input unit 30 by the operator. In addition, in addition to the rotation speed ratio calculator 42, the calculator 40 in this example includes a phase calculator 86 for calculating a phase of the rotary tool actualizing a rotation angle of the workpiece designated by the operator based on the number of polygon faces, input of which is received by the number-of-polygon-faces input receiver 12, the number of blades of the rotary tool, input of which is received by the number-of-blades input receiver 14, and a rotation speed ratio calculated by the rotation speed ratio calculator 42.

Information related to a phase corresponding to an input designated angle of the workpiece, the phase being calculated by the phase calculator 86, is transmitted to the display output unit 52, and is finally displayed on the display unit 70, for example, in a display format illustrated in FIG. 11 or 12.

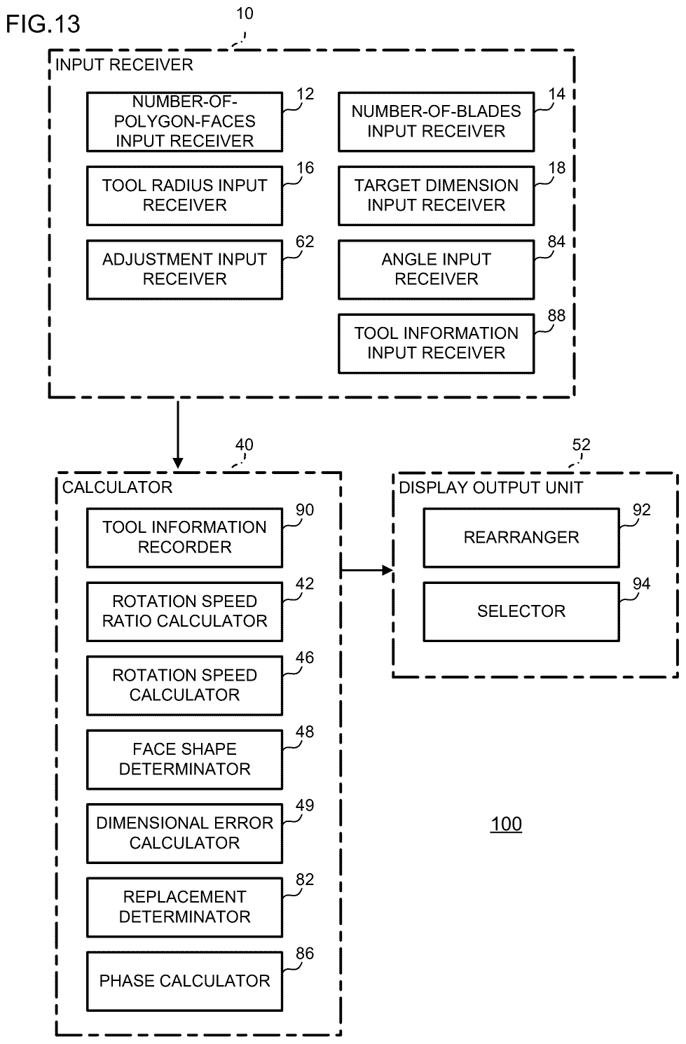

Next, still another embodiment of the invention will be described with reference to FIG. 13. According to a machining assistance apparatus 100 of an aspect described below, when there is a plurality of candidates for a rotary tool available for polygon machining, the operator can acquire machining assistance information related to suitability or unsuitability when using each tool via the display unit 70.

In addition to the various input receivers 12, 14, 16, 18, 62, and 84 described above, the input receiver 10 in the machining assistance apparatus 100 according to this aspect can include a tool information input receiver 88 for receiving input of information related to the number of blades, a rotation radius, etc. for a plurality of types of rotary tools serving as candidates for use during polygon machining. The tool information input receiver 88 can be considered to include the number-of-blades input receiver 14 and the tool radius input receiver 16 described above.

In addition to the tool information input receiver 88 or in place of the tool information input receiver 88, the machining assistance apparatus 100 may include a tool information recorder 90 for recording information related to the number of blades, a rotation radius, etc. in advance for a plurality of types of rotary tools serving as candidates for use during polygon machining.

The calculator 40 can execute various calculation processes or determination processes for each rotary tool serving as a candidate for use during polygon machining and acquire a result thereof as data, by using information acquired from at least one of the tool information input receiver 88 and the tool information recorder 90 as necessary. Examples of the calculation processes or the determination processes executable by the calculator at this time can include at least one of determination as to whether or not machining is possible using the rotation speed ratio calculator 42 and following matters if the calculator 42 determines that the machining is possible: calculation of a rotation speed ratio, calculation of a rotation speed by the rotation speed calculator 46, determination of a surface shape of the workpiece subjected to polygon machining by the face shape determinator 48, calculation of a dimensional error by the dimensional error calculator 49, determination related to presence or absence of blade replacement by the replacement determinator 82, or calculation of a phase corresponding to a designated angle of the workpiece by the phase calculator 86.

The calculator 40 transmits, to the display output unit 52, data of a result related to calculation or determination items corresponding to each rotary tool serving as a candidate for use during polygon machining.

The display output unit 52 receiving this information executes a process of causing the display unit 70 to display the calculation or determination result for each candidate for the rotary tool. As a result, for each of a plurality of rotary tool candidates, the display unit 70 displays results of determination as to whether polygon machining is possible, and calculation or determination of a rotation speed ratio, rotation speeds of the tool and the workpiece, a surface shape of the workpiece, a dimensional error, et cetera, the results being calculated or determined by the calculator 40. In this way, the machining assistance apparatus 100 can assist the operator in selecting the most suitable tool to use.

It is preferable that the display output unit 52 includes a rearranger 92 for executing output processing so that a candidate for a rotary tool determined to be available for polygon machining by the calculator 40 is rearranged according to any machining condition based on a calculation or determination result by the calculator 40 and then displayed on the display unit 70. Furthermore, it is preferable that the display output unit 52 includes a selector 94 for executing output processing so that only one or a plurality of rotary tools satisfying any machining condition among candidates for a rotary tool determined to be available for polygon machining by the calculator 40 is selected (filtered) and displayed on the display unit 70.

Rearrangement and selection of the candidate for the rotary tool can be executed using any calculation result or determination result derived by the calculator 40, that is, a result of determination as to whether or not machining is possible, and various calculation information such as a machining time calculated from a rotation speed and a dimensional error.

According to this aspect, an operator holding a plurality of rotary tools can understand in advance a rotary tool actualizing an optimal machining condition from among a plurality of rotary tool candidates displayed on the display unit 70. For example, when a machining condition that is most important to the operator is a machining time, a rotary tool with which a rotation speed calculated by the calculator 40 is highest and a machining time is shortest can be selected.

Even though several aspects of the invention have been described above, a specific method of implementing the invention is not limited to the above-mentioned aspects. As long as the invention can be implemented, changes in design, operating procedures and so on can be made as appropriate. For example, a component used to assist in exhibiting a function of a component used in the invention may be added or omitted as appropriate.

### EXPLANATIONS OF NUMERALS

10 INPUT RECEIVER
12 NUMBER-OF-POLYGON-FACES INPUT RECEIVER
14 NUMBER-OF-BLADES INPUT RECEIVER
16 TOOL RADIUS INPUT RECEIVER
40 CALCULATOR
42 ROTATION SPEED RATIO CALCULATOR
44 SPEED RANGE SETTER
46 ROTATION SPEED CALCULATOR
48 FACE SHAPE DETERMINATOR
49 DIMENSIONAL ERROR CALCULATOR
52 DISPLAY OUTPUT UNIT
82 REPLACEMENT DETERMINATOR
84 ANGLE INPUT RECEIVER
86 PHASE CALCULATOR
92 REARRANGER
94 SELECTOR

1. A machining assistance apparatus for calculating various data related to machining processing of a machine tool for cutting a workpiece into a polygon shape by rotating the workpiece and a tool at a certain ratio, the machining assistance apparatus comprising:
an input receiver including a number-of-polygon-faces input receiver configured to receive information related to the number of polygon faces of the workpiece formed by the cutting and a number-of-blades input receiver configured to receive input of information related to the number of blades attached to the tool, the input receiver being configured to receive input of information related to the machining processing;
a speed range setter configured to set axis rotation speeds of the tool and the workpiece in advance;
a calculator including a rotation speed ratio calculator configured to calculate a rotation speed ratio of the tool to the number of polygon faces based on the number of polygon faces and the number of blades, and a rotation speed calculator configured to calculate axis rotation speeds of the tool and the workpiece or candidates thereof based on the rotation speed ratio within a range of the set axis rotation speeds of the tool and the workpiece; and
a display output unit configured to output a calculation result by the calculator to a display unit connected to the machining assistance apparatus, and to cause the display unit to display the calculation result.

2. The machining assistance apparatus according to claim 1, wherein:
the input receiver further includes a tool radius input receiver configured to receive input of information related to a radius of the tool, and
the calculator further includes a dimensional error calculator configured to calculate a dimensional error occurring in the workpiece when the workpiece is cut into a polygon shape based on the number of polygon faces, the radius of the tool, and the rotation speed ratio.

3. The machining assistance apparatus according to claim 2, wherein, when the input receiver receives input of a command for reducing the dimensional error, or when the machining assistance apparatus determines that the dimensional error is to be reduced, the dimensional error calculator recalculates the dimensional error by varying a setting condition related to a distance between a center of the tool and a center of the workpiece.

4. The machining assistance apparatus according to any of claims 1 to 3, wherein the calculator further includes a face shape determinator configured to determine a shape of each face of the workpiece machined into a polygon shape based on the number of blades and the rotation speed ratio.

5. The machining assistance apparatus according to any of claims 1 to 4, wherein the calculator further includes a replacement determinator configured to determine whether or not a blade of the tool for cutting a predetermined surface of the workpiece is replaced every rotation of the tool when the workpiece is subjected to polygon machining based on the number of polygon faces, the number of blades, and the rotation speed ratio.

6. The machining assistance apparatus according to any of claims 1 to 5, wherein:
the input receiver further includes an angle input receiver configured to receive input related to a designated angle of the workpiece during polygon machining, and
the calculator further includes a phase calculator configured to calculate a phase of the tool actualizing a designated angle of the workpiece based on the number of polygon faces, the number of blades, and the rotation speed ratio.

7. The machining assistance apparatus according to any of claims 1 to 6, wherein:
when there is a plurality of types of tool candidates available for desired polygon machining, the calculator executes one or more calculation processes or determination processes related to the polygon machining for each of the tool candidates, and
the display output unit outputs a calculation result or a determination result by the calculator to the display unit and causes the display unit to display the calculation result or the determination result for each of the tool candidates.

8. The machining assistance apparatus according to claim 7, wherein the display output unit includes a rearranger configured to rearrange the tool candidates according to any machining condition based on the calculation result or the determination result by the calculator, and to cause the display unit to display the tool candidates.

9. The machining assistance apparatus according to claim 7 or 8, wherein the display output unit includes a selector configured to further select the tool candidates using any calculation or determination result derived by the calculator, and to cause the display unit to exclusively display the selected tool candidates.
